(19) United States
(12) Patent Application Publication
(10) Pub. No.: US 2017/0133019 A1
(43) Pub. Date: May 11, 2017

(54) METHOD AND DEVICE FOR VOICE CONTROL OVER ACCESS TO VIDEOS

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Chao CHU, Tianjin (CN); Lei YAN, Tianjin (CN)

(21) Appl. No.: 15/243,871

(22) Filed: Aug. 22, 2016

Related U.S. Application Data
(63) Continuation of application No. PCT/CN2016/089105, filed on Jul. 7, 2016.

(30) Foreign Application Priority Data
Nov. 10, 2015 (CN) 201510763182.2

(51) Int. Cl. G10L 17/08; H04N 21/4415; H04N 21/4627; H04N 21/258; G10L 17/24; H04N 21/454

(52) U.S. Cl. CPC G10L 17/08; G10L 17/24; H04N 21/454; H04N 21/4627; H04N 21/25875; H04N 21/4415

(57) ABSTRACT

An embodiment of the present disclosure discloses a method and a device for voice control over access to videos. The method comprises steps of receiving a video play request; displaying the prompt for entering the voice password according to the request; receiving the voice password, comparing the voice print of the voice password respectively with the voice print of a pre-recorded voice password and the voice print of a pre-recorded voice of a banned user to obtain a voice print similarity; and giving the corresponding access to videos according to the voice print similarity. Through device method and device according to the embodiment of the present disclosure, the user can record the voice password and the voice of the banned user in the smart TV.

### CROSS-REFERENCE TO RELATED APPLICATIONS

The present disclosure is a continuation of International Application No. PCT/CN2016/089105 filed on Jul. 7, 2016, which is based upon and claims priority to Chinese Patent Application No. 201510763182.2, entitled “METHOD AND DEVICE FOR VOICE CONTROL OVER ACCESS TO VIDEOS”, filed on Nov. 10, 2015, the entire contents of all of which are incorporated herein by reference.

### TECHNICAL FIELD

The present disclosure generally relates to the technical field of smart TVs, in particular to a method and a device for voice control over access to videos.

### BACKGROUND

Smart TV owns application platform advantages that traditional TV manufacturers do not have. A smart TV can provide a variety of application servers such as network searches, digital music, network news, network video calls, etc. Smart TVs have come to rank as the third frequently accessed terminals after computers and mobile phones. Users can access required information at any time. TVs will also become smart devices, realizing cross-platform searches among TV, network and programs. The smart TVs will also be an “entertainment center” in which users can search TV channels, record TV programs, and play satellite and cable TV programs and network videos.

At present, smart TVs are public household appliances, and all family members can use smart TVs. However, some videos stored in or played by the smart TVs are not suitable for the whole family; some members of a family may watch videos that other members don't want them to watch, which may cause leakage of users' privacy.

Therefore, a technical problem that is urgently needs to be solved by those skilled in this field is how to protect users' privacy in use of public household appliances like smart TVs.

### SUMMARY

An embodiment of the present disclosure discloses a method and a device for voice control over access to videos to solve the technical problem of the leakage of users' privacy which may occur because smart TVs in the prior art are public household appliances.

According to one aspect of the present disclosure, the present disclosure discloses a method for voice control over access to videos, including:

receiving a request for playing a video;

displaying a prompt for entering a voice password according to the request;

receiving the voice password, comparing the voice print of the voice password respectively with the voice print of a pre-recorded voice password and the voice print of a pre-recorded voice of a banned user to obtain a voice print similarity:

and giving corresponding access to videos according to the voice print similarity.

According to another aspect of the present disclosure, the present disclosure discloses a device for voice control over access to videos, including at least one processor; and a memory communicably connected with the at least one processor for storing instructions executable by the at least one processor, wherein execution of the instructions by the at least one processor causes the at least one processor to:

receive a request for playing a video;

display a prompt for entering a voice password according to the request;

receive the voice password, compare the voice print of the voice password respectively with the voice print of a pre-recorded voice password and the voice print of a pre-recorded banned user voice to obtain a voice print similarity;

and give corresponding access to videos according to the voice print similarity.

According to another aspect of the present disclosure, the present discloses a computer program, including computer readable codes, wherein the computer readable codes operate on a smart TV such that the smart TV executes the method for voice control over access to videos.

Another embodiment of the present disclosure discloses a non-transitory computer readable medium storing executable instructions that, when executed by an electronic device, cause the electronic device to:

receive a request for playing a video;

display a prompt for entering a voice password according to the request;

receive the voice password, compare the voice print of the voice password respectively with the voice print of a pre-recorded voice password and the voice print of a pre-recorded voice of a banned user to obtain a voice print similarity; and

give corresponding access to videos according to the voice print similarity.

The present disclosure has the following beneficial effects:

The embodiment of the present disclosure provides a method and a device for voice control over access to videos. The user can record the voice password and the voice of the banned user in the smart TV; before playing a video, the smart TV compares the voice print of the voice password sent by a user who wants to watch the video with the voice print of the pre-recorded voice password and the voice print of the pre-recorded voice of the banned user, determines if the user who wants to watch the video is the user who has recorded the voice password, and if not, which means that the user does not have the access to the video, does not allow the user to watch the video, thus protecting the privacy of other users.

The above description is a summary of the solution of the present disclosure. In order to more clearly describe the technical means of the present disclosure, the content of the description can be executed. Moreover, in order to ensure that the above and other objectives, characteristics and advantages of the present disclosure are more understandable, embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a method for voice control over access to videos according to an embodiment of the present disclosure:

FIG. 2 is a step flowchart of a method for voice control over access to videos according to an embodiment of the present disclosure;

FIG. 3 is a structural block diagram of a device for voice control over access to videos according to an embodiment of the present disclosure;

FIG. 4 is a structural block diagram of a device for voice control over access to videos according to an embodiment of the present disclosure;

FIG. 5 schematically illustrates a block diagram of an electronic device for executing the method according to the present disclosure; and

FIG. 6 schematically illustrates a storage unit for holding or carrying program codes for realizing the method according to the present disclosure.

### DESCRIPTION OF THE EMBODIMENTS

To make clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which all shall fall within the protection scope of the present disclosure.

Voice print is an acoustic wave frequency spectrum which is displayed by an electro-acoustic instrument and carries voice information. Modern scientific researches show that the voice print not only has specificality, but also has the characteristic of relative stability. An adult's voice can keep relatively stable and unchanged for a long time. Experiments show that the voice prints of different persons are always different no matter how much similarly a person simulates the voice and mood of another person or even speaks in a soft voice.

Based on the above principle, an embodiment of the present disclosure provides a method and a device for voice control over access to videos to solve the technical problem of leakage of user's privacy which may occur, because smart TV's are public household appliances.

### Embodiment 1

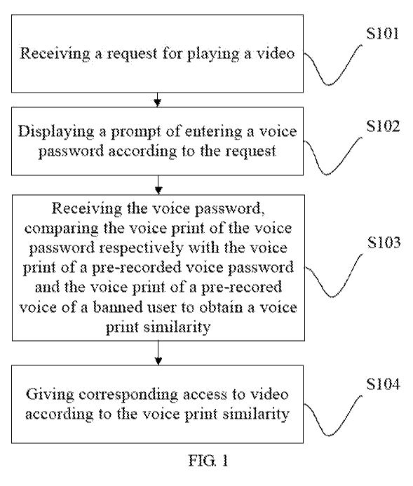

Refer to FIG. 1, which is a step flowchart of a method for voice control over access to videos according to the embodiment of the present disclosure.

In order to solve the above technical problem, the embodiment of the present disclosure provides a method for voice control over access to videos. As shown in FIG. 1, the method can include the following steps.

Step S101: Receive a request for playing a video.

In this step, a user turns on a smart TV, and can send a video play request to the smart TV through a remote controller. The video play request can be a request for playing videos via conventional cables, for example videos supplied by BCCTV, and can also be a request for playing network videos, for example network videos supplied by Letv network. The video play request can be a request for playing videos of a certain TV station, for example, videos of Hunan TV station, can be a request for playing videos of a video website, for example videos of Letv network, and can also be a request for playing a certain type of videos, for example comedies and romantic videos. Of course, the request can also be a request for playing a certain video, for example, “Monster Hunt”.

Step S102: Display a prompt for entering a voice password according to the request.

At present, the smart TV directly plays the corresponding video after receiving the video play request. For example, after receiving the request for playing “Hunan TV station”, the smart TV directly plays videos which are being broadcast by “Hunan TV station”, such as “Where are we going, Dad”. Anyone can randomly watch the video played on the smart TV, and there are no limits placed on the video audience, resulting in that some users can watch videos which are not suitable for those users. For example, a 10-year old boy watches the movie “Young and Dangerous”.

To avoid the above situations, in this step, the smart TV displays the prompt for entering the voice password on the screen which must be checked by the user after receiving the video play request, and the prompt for entering the voice password can be presented on the screen in the form of a subtitle, for example the subtitle “Please enter the voice password” or “Please talk to me” is presented to prompt the user who sends the video play request to say the password. The voice password is a word or a sentence that the user speaks after watching the prompt for entering the voice password that is displayed on the screen, and is used for acquiring the access to the video.

Step S103: Receive the voice password, and compare the voice print of the voice password respectively with the voice print of a pre-recorded voice password and the voice print of a pre-recorded voice of a banned user to obtain a voice print similarity.

In this step, the pre-recorded voice password can be the voice, recorded in the smart TV in advance, of the user who sets the access to videos, and the recorded voice of the banned user can be the voice, recorded in the smart TV in advance, of the user who has no access to the video. Taking a current Chinese family structure as an example, the family members include two old persons, a middle-aged couple, a 6-year old girl and a 10-year old boy. The middle-aged couple sets the play authority of the smart TV; in the smart TV, the voices of the middle-aged couple are pre-recorded as the pre-recorded voice passwords, and the voices of the two children are pre-recorded as the pre-recorded voices of banned users.

According to this embodiment of the present disclosure, the comparison of the voice prints can be implemented by using a voice print diagram. In the voice print diagram, the horizontal coordinate represents time; the vertical coordinate represents frequency; and the intensity represents the loudness of a voice. The front portion of the voice print of every word is the frequency spectrum of a voiceless consonant, while the rear portion is a frequency spectrum of a vowel; and in the frequency spectrum of the vowel, the horizontal black tape consisting of intensified vertical lines is a resonance peak. The quantity, trend and frequency of the resource peak are important characteristics for voice print analysis. Therefore, the voice print similarity can be any one of quantity similarity, trend similarity and frequency similarity of the resource peak.

Step S104: Give corresponding access to videos according to the voice print similarity.

In this step, if the voice is highly similar to the voice print of the pre-recorded voice password and but has low similarity to the voice print of the pre-recorded voice of the banned user, the access to the videos or with play of some of the videos can be given; otherwise, the authority with the video play cannot be given.

The above family is continuously taken as an example. If the voice prints of the voice passwords entered by the middle-aged couple are highly similar to the pre-recorded voice passwords, then the access to all videos can be given. If the voice prints of the voice passwords entered by the two old persons are relatively of high similarity to the pre-recorded voice passwords and relatively lowly similar to the voice prints of the pre-recorded voices of the banned users, then the access to some videos can be given. If the voice prints of the voice passwords entered by the two children are highly similar to the voice prints of the pre-recorded voices of the banned users, then the two children can be banned from watching the videos.

Through the method for voice control over access to videos provided according to the embodiment of the present disclosure, the user can record the voice password and the voice of the banned user in the smart TV; before playing a video, the smart TV compares the voice print of the voice password sent by a user who wants to watch the video with the voice print of the pre-recorded voice password and the voice print of the pre-recorded voice of the banned user, determines if the user who wants to watch the video is the user who has recorded the voice password, and if not, which means that the user does not have the access to the video, does not allow the user to watch the video, thus protecting the privacy of other users.

Background noises, such as the sound of wind, flowing water and dogs barking, occur in the user's environment. Therefore, the present disclosure provides an optimal embodiment to optimize the step S103 in the following way of: receiving the voice password, determining if the voice password are capable of being converted into text through voice identification technologies; and if the voice passwords are capable of being converted into text, executing the operation of comparing the voice print of the voice password respectively with the voice print of the pre-recorded voice password and the voice print of the pre-recorded voice of the banned user to obtain the voice print similarity.

According to this optimal embodiment, the background noises cannot be converted into the texts, so the sound waves of the background noises are not compared with the voice prints of the pre-recorded voice passwords and the voice prints of the pre-recorded voices of the banned users.

### Embodiment 2

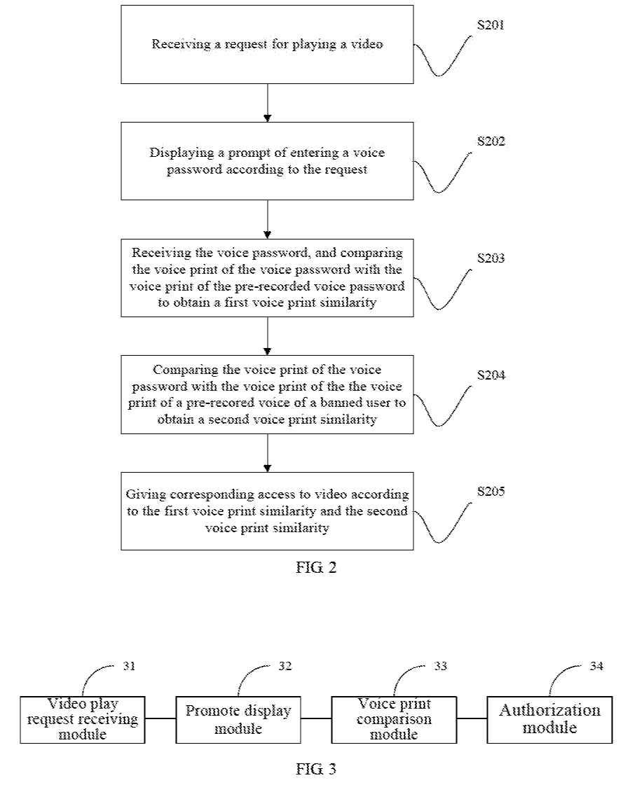

FIG. 2 is a step flowchart of a method for voice control over access to videos according to an embodiment of the present disclosure;

On the basis of the first embodiment of the present disclosure, the second embodiment of the present disclosure provides a method for voice control over access to videos. As shown in FIG. 2, the method can include the following steps.

Step S201: Receive a request for playing a video.

Step S202: Display a prompt for entering a voice password according to the request.

Step S203: Receive the voice password, and comparing the voice print of the voice password with the voice print of the pre-recorded voice password to obtain a first voice print similarity.

Step S204: Compare the voice print of the voice password with the voice print of a pre-recorded voice of a banned user to obtain a second voice print similarity.

Step S205: Give corresponding access to videos according to the first voice print similarity and the second voice print similarity.

In this step, the first voice print similarity and the second voice print similarity can be respectively compared with the preset voice print similarity;

if the first voice print similarity is greater than or equal to the preset voice print similarity and the second voice print similarity is less than the preset voice print similarity, the access to all videos is given;

if the first voice print similarity is less than the preset voice print similarity and the second voice print similarity is less than the preset voice print similarity, the access to some videos is given;

and if the first voice print similarity is less than the preset voice print similarity and the second voice print similarity is greater than or equal to the preset voice print similarity, the access to some videos is given.

Through the method for voice control over access to videos provided according to the embodiment of the present disclosure, the user can record the voice password and the voice of the banned user in the smart TV; before playing a video, the smart TV compares the voice print of the voice password sent by a user who wants to watch the video with the voice print of the pre-recorded voice password and the voice print of the pre-recorded voice of the banned user, determines if the user who wants to watch the video is the user who has recorded the voice password, and if not, which means that the user does not have the access to the video, does not allow the user to watch the video, thus protecting the privacy of other users.

According to an optimal embodiment of the present disclosure, after the step of giving the access to some videos if the first voice print similarity is less than the preset voice print similarity and the second voice print similarity is less than the preset voice print similarity, the method also includes the steps of displaying a prompt for additionally recording the voice password;

then, receiving the additionally recorded voice password and storing the additionally recorded voice password. The prompt for additionally recording the voice password may be the prompt for entering neither the pre-recorded voice password nor the prompt for additionally recording the voice password of the banned with the pre-recorded voice in the smart TV, but voice passwords of persons such as guests of the family and the above mentioned two old family members so as to obtain an access to more videos.

### Embodiment 3

Refer to FIG. 3, which is a structural block diagram of a device for voice control over access to videos according to the embodiment of the present disclosure.

The third embodiment of the present disclosure provides a device for voice control over access to videos, which is a device capable of implementing the method for voice control over access to videos according to the first embodiment of the present disclosure. As shown in FIG. 3, the device can include the following modules: a video play request receiving module 31, a prompt display module 32, a voice print comparison module 33 and an authorization module 34.

According to this embodiment of the present disclosure, the video play request receiving module 31 is used for receiving a video play request; the prompt display module 32 is used for displaying the prompt for entering the voice password according to the request, the voice print comparison module 33 is used for receiving the voice password, comparing the voice print of the voice password respectively with the voice print of a pre-recorded voice password and the voice print of the pre-recorded voice of a banned user voice to obtain a voice print similarity; and the authorization module 34 is used for giving the corresponding access to videos according to the voice print similarity.

In the video play request receiving module 31, a user turns on a smart TV, and can send a video play request to the smart TV through a remote controller. The video play request can be a request for playing videos via conventional cables, for example videos supplied by BCCTV, and can also be a request for playing network videos, for example network videos supplied by Letv network. The video play request can be a request for playing videos of a certain TV station, for example, videos of Hunan TV station, can be a request for playing videos of a video website, for example videos of Letv network, and can also be a request for playing a certain type of videos, for example comedies and romantic videos. Of course, the request can also be a request for playing a certain video, for example, “Monster Hunt”

In the prompt display module 32, the smart TV displays the prompt for entering the voice password on the screen which must be checked by the user after receiving the video play request, and the prompt for entering the voice password can be presented on the screen in the form of a subtitle; for example the subtitle “Please enter the voice password” or “Please talk to me” is presented to prompt the user who sends the video play request to say the password. The voice password is a word or a sentence that the user speaks after watching the prompt for entering the voice password that is displayed on the screen, and is used for acquiring the access to the video.

In the voice print comparison module 33, the pre-recorded voice password can be the voice, recorded in the smart TV in advance, of the user who sets the access to videos, and the recorded voice of the banned user can be the voice, recorded in the smart TV in advance, of the user who has no access to the video. The comparison of the voice prints can be implemented by using a voice print diagram. In the voice print diagram, the horizontal coordinate represents time; the vertical coordinate represents frequency; and the intensity represents the loudness of a voice. The front portion of the voice print of every word is the frequency spectrum of a voiceless consonant, while the rear portion is a frequency spectrum of a vowel; and in the frequency spectrum of the vowel, the horizontal black tape consisting of intensified vertical lines is a resonance peak. The quantity, trend and frequency of the resource peak are important characteristics for voice print analysis. Therefore, the voice print similarity can be any one of quantity similarity, trend similarity and frequency similarity of the resource peak.

In the authorization module 34, if the voice is highly similar to the voice print of the pre-recorded voice password and has low similarity to the voice print of the pre-recorded voice of the banned user, the access to the videos or with play of some of the videos can be given; otherwise, the authority with the video play cannot be given.

Through the device for voice control over access to videos provided in the embodiment of the present disclosure, the user can record the voice password and the voice of the banned user in the smart TV; before playing a video, the smart TV compares the voice print of the voice password sent by a user who wants to watch the video with the voice print of the pre-recorded voice password and the voice print of the pre-recorded voice of the banned user, determines if the user who wants to watch the video is the user who has recorded the voice password, and if not, which means that the user does not have the access to the video, does not allow the user to watch the video, thus protecting the privacy of other users.

Background noises, such as the sound of wind, flowing water and dogs barking, occur in the user's environment. Therefore, the present disclosure provides an optimal device to execute the above optimal embodiment. The optimal device not only includes all modules of the above device for voice control over access to videos, but also includes:

a text conversion module for receiving the voice password, determining if the voice password is capable of being converted into texts through voice identification technologies, and if the voice password is capable of being converted into texts, executing the operation of the voice print comparison module.

In the optimal device, the background noises cannot be converted into the texts, so the sound waves of the background noises are not compared with the voice prints of the pre-recorded voice passwords and the voice prints of the pre-recorded voices of the banned users.

### Embodiment 4

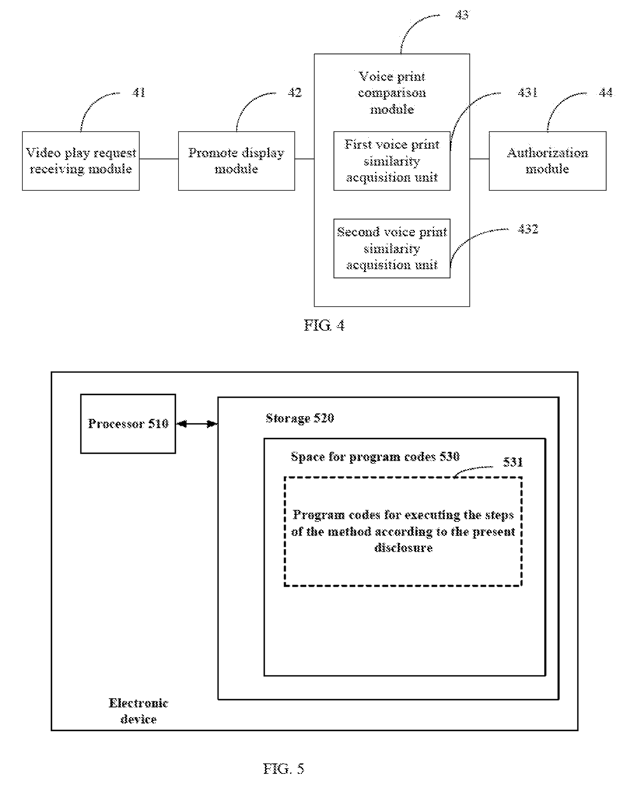

FIG. 4 is a structural block diagram of a device for voice control over access to videos according to an embodiment of the present disclosure; The fourth embodiment of the present disclosure provides a device for voice control over access to videos, which is a device capable of implementing the method for voice control over access to videos according to the third embodiment of the present disclosure. As shown in FIG. 4, the device includes a video play request receiving module 41, a prompt display module 42, a voice print comparison module 43 and an authorization module 44.

According to this embodiment of the present disclosure, the video play request receiving module 41 is used for receiving a video play request; the prompt display module 42 is used for displaying the prompt for entering the voice password according to the request; the voice print comparison module 43 includes a first voice print similarity acquisition unit 431 and a second voice print similarity acquisition unit 432; the first voice print similarity acquisition unit 431 is used for receiving the voice password and comparing the voice print of the voice password with the voice print of the pre-recorded voice password to obtain a first voice print similarity; the second voice print similarity acquisition unit 432 is used for comparing the voice print of the voice password with the voice print of the pre-recorded voice of a banned user to obtain a second voice print similarity; and the authorization module 44 is used for giving the corresponding access to videos according to the first voice print similarity and the second voice print similarity.

In the authorization module 44, the first voice print similarity and the second voice print similarity can be compared with a preset voice print similarity respectively; if the first voice print similarity is greater than or equal to the preset voice print similarity, while the second voice print similarity is less than the preset voice print similarity, the access to all videos will be given; if the first voice print similarity is less than the preset voice print similarity, while the second voice print similarity is less than the preset voice print similarity, the access to some videos will be given; and if the first voice print similarity is less than the preset voice print similarity, while the second voice print similarity is greater than or equal to the preset voice print similarity, the access to videos will not be given.

Through the device for voice control over access to videos provided in the embodiment of the present disclosure, the user can record the voice password and the voice of the banned user in the smart TV; before playing a video, the smart TV compares the voice print of the voice password sent by a user who wants to watch the video with the voice print of the pre-recorded voice password and the voice print of the pre-recorded voice of the banned user, determines if the user who wants to watch the video is the user who has recorded the voice password, and if not, which means that the user does not have the access to the video, does not allow the user to watch the video, thus protecting the privacy of other users.

The present disclosure discloses an optimal device. After the access to some videos is given in the case that the first voice print similarity is less than the preset voice print similarity and the second voice print similarity is less than the preset voice print similarity, the device also includes an additional recording display module and an additional recording voice receiving module.

The additional recording prompt display module is used for displaying a prompt for additionally recording a voice password.

The additionally recorded voice receiving module is used for receiving the additionally recorded voice password and storing the additionally recorded voice password.

In the optimal device, the prompt for additionally recording the voice password may be the prompt for entering neither the pre-recorded voice password nor the prompt for additionally recording the voice password of the banned with the pre-recorded voice in the smart TV, but voice passwords of persons such as guests of the family and the above mentioned two old family members so as to obtain an access to more videos.

The device embodiment described above is schematic, wherein units described as separable parts may be or may not be physically separated, and components displayed as units may be or may not be physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

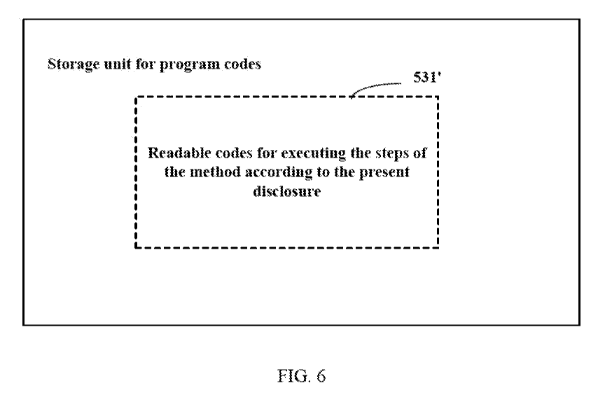

For example, FIG. 5 illustrates a block diagram of an electronic device for executing the method for voice control over access to videos according the disclosure. The electronic device may be the smart TV above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that, the above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for voice control over access to videos, comprising:
receiving a request for playing a video;
displaying a prompt for entering a voice password according to the request;
receiving the voice password, comparing the voice print of the voice password respectively with the voice print of a pre-recorded voice password and the voice print of a pre-recorded voice of a banned user to obtain a voice print similarity;
and giving corresponding access to videos according to the voice print similarity.

2. The method according to claim 1, wherein receiving the voice password, comparing the voice print of the voice password respectively with the voice print of a pre-recorded voice password and the voice print of a pre-recorded voice of a banned user to obtain a voice print similarity, and giving corresponding access to videos according to the voice print similarity comprises:
receiving the voice password, and comparing the voice print of the voice password with the voice print of the pre-recorded voice password to obtain a first voice print similarity;
comparing the voice print of the voice password with the voice print of a pre-recorded voice of a banned user to obtain a second voice print similarity,
and giving corresponding access to videos according to the first voice print similarity and the second voice print similarity.

3. The method according to claim 2, wherein giving corresponding access to videos according to the first voice print similarity and the second voice print similarity comprises:
comparing the first voice print similarity and the second voice print similarity with the preset voice print similarity respectively;
if the first voice print similarity is greater than or equal to the preset voice print similarity and the second voice print similarity is less than the preset voice print similarity, giving the access to all videos;
if the first voice print similarity is less than the preset voice print similarity and the second voice print similarity is less than the preset voice print similarity, giving the access to some videos;
and if the first voice print similarity is less than the preset voice print similarity and the second voice print similarity is greater than or equal to the preset voice print similarity, giving no access to videos.

4. The method according to claim 3, wherein, after giving the access to some videos if the first voice print similarity is less than the preset voice print similarity and the second voice print similarity is less than the preset voice print similarity, the method further comprises:
displaying a prompt for additionally recording a voice password;
receiving the additionally recorded voice password and storing the additionally recorded voice password.

5. The method according to claim 1, wherein, after receiving the voice password, and comparing the voice print of the voice password respectively with the voice print of the pre-recorded voice password and the voice print of the pre-recorded voice of a banned user to obtain a voice print similarity, the method further comprises:
receiving the voice password, and determining if the voice password is capable of being converted into texts through voice identification technologies:
if the voice passwords are capable of being converted into texts, executing the operation of comparing the voice print of the voice password respectively with the voice print of a pre-recorded voice password and the voice print of a pre-recorded banned user voice to obtain a voice print similarity.

6. An electronic device for voice control over access to videos, comprising:
at least one processor; and
a memory communicably connected with the at least one processor for storing instructions executable by the at least one processor, wherein execution of the instructions by the at least one processor causes the at least one processor to:
receive a request for playing a video;
display a prompt for entering a voice password according to the request;
receive the voice password, compare the voice print of the voice password respectively with the voice print of a pre-recorded voice password and the voice print of a pre-recorded banned user voice to obtain a voice print similarity;
give corresponding access to videos according to the voice print similarity.

7. The electronic device according to claim 6, wherein receive the voice password, compare the voice print of the voice password respectively with the voice print of a pre-recorded voice password and the voice print of a pre-recorded banned user voice to obtain a voice print similarity comprises:
receive the voice password, and compare the voice print of the voice password with the voice print of the pre-recorded voice password to obtain a first voice print similarity,
compare the voice print of the voice password with the voice print of the pre-recorded voice of a banned user to obtain a second voice print similarity;
wherein give corresponding access to videos according to the voice print similarity comprises give corresponding access to videos according to the first voice print similarity and the second voice print similarity.

8. The electronic device according to claim 7, wherein give corresponding access to videos according to the voice print similarity comprises compare the first voice print similarity and the second voice print similarity with the preset voice print similarity respectively;
if the first voice print similarity is greater than or equal to the preset voice print similarity and the second voice print similarity is less than the preset voice print similarity, give the access to all videos;
if the first voice print similarity is less than the preset voice print similarity and the second voice print similarity is less than the preset voice print similarity, give the access to some videos;
and if the first voice print similarity is less than the preset voice print similarity and the second voice print similarity is greater than or equal to the preset voice print similarity, give no access to videos.

9. The electronic device according to claim 8, wherein execution of the instructions by the at least one processor causes the at least one processor to further:
display a prompt for additionally recording a voice password;
receive the additionally recorded voice password and storing the additionally recorded voice password.

10. The electronic device according to claim 6, wherein execution of the instructions by the at least one processor causes the at least one processor to further:
receive the voice password, and determine if the voice password is capable of being converted into texts through voice identification technologies;
and if the voice password is capable of being converted into texts, execute the operation of comparing the voice print of the voice password respectively with the voice print of a pre-recorded voice password and the voice print of a pre-recorded banned user voice to obtain a voice print similarity.

11. A non-transitory computer readable medium storing executable instructions that, when executed by an electronic device, cause the electronic device to:
receive a request for playing a video;
display a prompt for entering a voice password according to the request;
receive the voice password, compare the voice print of the voice password respectively with the voice print of a pre-recorded voice password and the voice print of a pre-recorded voice of a banned user to obtain a voice print similarity; and
give corresponding access to videos according to the voice print similarity.

12. The non-transitory computer readable medium according to claim 11, wherein receive the voice password, compare the voice print of the voice password respectively with the voice print of a pre-recorded voice password and the voice print of a pre-recorded banned user voice to obtain a voice print similarity comprises:
receive the voice password, and compare the voice print of the voice password with the voice print of the pre-recorded voice password to obtain a first voice print similarity,
compare the voice print of the voice password with the voice print of the pre-recorded voice of a banned user to obtain a second voice print similarity;
wherein give corresponding access to videos according to the voice print similarity comprises give corresponding access to videos according to the first voice print similarity and the second voice print similarity.

13. The non-transitory computer readable medium according to claim 12, wherein give corresponding access to videos according to the voice print similarity comprises compare the first voice print similarity and the second voice print similarity with the preset voice print similarity respectively:
if the first voice print similarity is greater than or equal to the preset voice print similarity and the second voice print similarity is less than the preset voice print similarity, give the access to all videos;
if the first voice print similarity is less than the preset voice print similarity and the second voice print similarity is less than the preset voice print similarity, give the access to some videos;
and if the first voice print similarity is less than the preset voice print similarity and the second voice print similarity is greater than or equal to the preset voice print similarity, give no access to videos.

14. The non-transitory computer readable medium according to claim 13, wherein execution of the instructions by the at least one processor causes the at least one processor to further:
display a prompt for additionally recording a voice password;
receive the additionally recorded voice password and store the additionally recorded voice password.

15. The non-transitory computer readable medium according to claim 11, wherein the electronic device is further caused to:
receive the voice password, and determine if the voice password is capable of being converted into texts through voice identification technologies;
and if the voice password is capable of being converted into texts, execute the operation of comparing the voice print of the voice password respectively with the voice print of a pre-recorded voice password and the voice print of a pre-recorded banned user voice to obtain a voice print similarity.
